(19) United States
(12) Patent Application Publication
(10) Pub. No.: US 2025/0159455 A1
(43) Pub. Date: May 15, 2025

(54) GEO GUIDANCE FOR LEO COVERAGE AND CONNECTIVITY

(71) Applicant: Nokia Technologies Oy, Espoo (FI)

(72) Inventors: Rafhael MEDEIROS DE AMORIM, Aalborg (DK); Jeroen WIGARD, Klarup (DK)

(73) Assignee: Nokia Technologies Oy, Espoo (FI)

(21) Appl. No.: 18/838,010

(22) PCT Filed: Feb. 14, 2022
(86) PCT No.: PCT/US2022/016274

§ 371 Date: Aug. 13, 2024

(51) Int. Cl. H04W 8/00; H04W 48/18; H04W 84/04; H04W 84/06

(52) U.S. Cl. CPC H04W 8/005; H04W 48/18; H04W 84/042; H04W 84/06

(57) ABSTRACT

Message(s) are created to be transmitted over a geostationary system. The message(s) include coverage information for non-geo stationary satellite(s) in an NTN from PLMN(s). The message(s) are transmitted over the geostationary system. A UE searches for a PLMN. The UE, in response to finding a PLMN transmitting, using a geostationary system, message(s) including coverage information for non-geo stationary satellite(s) in an NTN, receives the message(s). The UE updates preferences used for a list used for PLMN selection to make PLMN(s) corresponding to the coverage information as higher priority than other PLMN(s) in the list. The UE performs cell search(es) for cells from the non-geo stationary satellite(s) using the updated list.

### TECHNICAL FIELD

Exemplary embodiments herein relate generally to geostationary (GEO) and low-earth orbit (LEO) networks or networks with other non-geostationary objects (NGSOs) and, more specifically, relates to these networks' communications with terrestrial networks (TNs).

### BACKGROUND

The 3GPP (third generation partnership project) have started a work item (WI) on non-terrestrial networks (NTNs) in release 17 (see, e.g., RP-193234, Thales, “Solutions for NR to support non-terrestrial networks (NTN)”, 3GPP TSG RAN meeting #86, Sitges, Spain, Dec. 9-13, 2019), based on the NTN study item (SI) in release 16. The outcome of the SI is reported in the 3GPP TR 38.821 (see, e.g., 3GPP TR 38.821 V16.1.0 (2021-05)). It is expected that the topic will continue with a new WI in rel. (release) 18, for which the content is being discussed.

NTNs cover geostationary (GEO) and low-earth orbit (LEO) networks, or networks with other non-geostationary objects (NGSOs), among others. The target is to deploy 5G New Radio (NR) using the NTN framework, where the gNBs (NR base stations that provide access to the network) can be either relayed through (transparent architecture, rel. 17) or located on (regenerate architecture, rel. 18) the satellites/stations.

The biggest challenge with GEO satellites is the distance from earth (approx. 36000 km), leading to large delays (relative to the NTN framework) and a poor link budget. In particular, since a link budget can be defined as the relationship between transmitted and received power in a radio system, including all gains and losses, this distance will mean a large difference between received and transmitted power, thus leading to the poor link budget. These and other issues should be addressed.

### BRIEF SUMMARY

This section is intended to include examples and is not intended to be limiting.

In an exemplary embodiment, a method is disclosed that include creating one or more messages to be transmitted over a geostationary system, the one or more messages comprising coverage information for one or more non-geostationary satellites in a non-terrestrial network from one or more public land mobile networks. The method also includes transmitting over the geostationary system the one or more messages.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus at least to: create one or more messages to be transmitted over a geostationary system, the one or more messages comprising coverage information for one or more non-geostationary satellites in a non-terrestrial network from one or more public land mobile networks; and transmit over the geostationary system the one or more messages.

An exemplary computer program product includes a computer-readable storage medium bearing computer program code embodied therein for use with a computer. The computer program code includes: code for creating one or more messages to be transmitted over a geostationary system, the one or more messages comprising coverage information for one or more non-geostationary satellites in a non-terrestrial network from one or more public land mobile networks; and code for transmitting over the geostationary system the one or more messages.

In another exemplary embodiment, an apparatus comprises means for performing: creating one or more messages to be transmitted over a geostationary system, the one or more messages comprising coverage information for one or more non-geostationary satellites in a non-terrestrial network from one or more public land mobile networks; and transmitting over the geostationary system the one or more messages.

In an exemplary embodiment, a method is disclosed that includes searching, by a user equipment, for a public land mobile network, and, in response to finding a public land mobile network transmitting, using a geostationary system, one or more messages comprising coverage information for one or more non-geostationary satellites in a non-terrestrial network, receiving by the user equipment the one or messages. The method also includes updating by the user equipment preferences used for a list used for public land mobile network selection to make one or more public land mobile networks corresponding to the coverage information as higher priority than other public land mobile networks in the list. The method additionally includes performing by the user equipment one or more cell searches for cells from the one or more non-geostationary satellites using the updated list.

An exemplary apparatus includes one or more processors and one or more memories including computer program code. The one or more memories and the computer program code are configured to, with the one or more processors, cause the apparatus at least to search, by a user equipment, for a public land mobile network; in response to finding a public land mobile network transmitting, using a geostationary system, one or more messages comprising coverage information for one or more non-geostationary satellites in a non-terrestrial network, receive by the user equipment the one or messages; update by the user equipment preferences used for a list used for public land mobile network selection to make one or more public land mobile networks corresponding to the coverage information as higher priority than other public land mobile networks in the list; and perform by the user equipment one or more cell searches for cells from the one or more non-geostationary satellites using the updated list.

An exemplary computer program product includes a computer-readable storage medium bearing computer program code embodied therein for use with a computer. The computer program code includes: code for searching, by a user equipment, for a public land mobile network; code for in response to finding a public land mobile network transmitting, using a geostationary system, one or more messages comprising coverage information for one or more non-geostationary satellites in a non-terrestrial network, receiving by a user equipment the one or messages; code for updating by the user equipment preferences used for a list used for public land mobile network selection to make one or more public land mobile networks corresponding to the coverage information as higher priority than other public land mobile networks in the list; and code for performing by the user equipment one or more cell searches for cells from the one or more non-geostationary satellites using the updated list.

In another exemplary embodiment, an apparatus comprises means for performing: searching, by a user equipment, for a public land mobile network; in response to finding a public land mobile network transmitting, using a geostationary system, one or more messages comprising coverage information for one or more non-geostationary satellites in a non-terrestrial network, receiving by the user equipment the one or messages; updating by the user equipment preferences used for a list used for public land mobile network selection to make one or more public land mobile networks corresponding to the coverage information as higher priority than other public land mobile networks in the list; and performing by the user equipment one or more cell searches for cells from the one or more non-geostationary satellites using the updated list.

### BRIEF DESCRIPTION OF THE DRAWINGS

In the attached Drawing Figures:

FIG. 1 is a diagram of one possible and non-limiting exemplary system in which the exemplary embodiments may be practiced;

FIGS. 1A and 1B illustrate additional possible configurations for FIG. 1;

FIG. 1C illustrates another configuration for the system of FIG. 1;

FIG. 1D illustrates an apparatus that may be used for any of the entities in FIG. 1;

FIG. 2 is referred to as Table 1, which illustrates achievable throughput for a handheld UE in uplink and downlink at 2 GHz for GEO and LEO at 600 km;

FIG. 3 is a logic flow diagram performed by a network for GEO guidance for LEO coverage and connectivity, in accordance with an exemplary embodiment;

FIG. 4 is a logic flow diagram performed by a UE for GEO guidance for LEO coverage and connectivity, in accordance with an exemplary embodiment;

FIG. 5 is a logic flow diagram performed by a UE and a network for GEO guidance for LEO coverage and connectivity, in accordance with a first exemplary implementation;

FIG. 6 is a table illustrating a timetable with next LEO coverage times and probabilities;

FIG. 7 is a logic flow diagram performed by a UE for GEO guidance for LEO coverage and connectivity, in accordance with the first exemplary implementation; and

FIG. 8 is part of a logic flow diagram performed by a UE and a network for GEO guidance for LEO coverage and connectivity, in accordance with a second exemplary implementation.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

The exemplary embodiments herein describe techniques for GEO guidance for LEO coverage and connectivity. Additional description of these techniques is presented after a system into which the exemplary embodiments may be used is described.

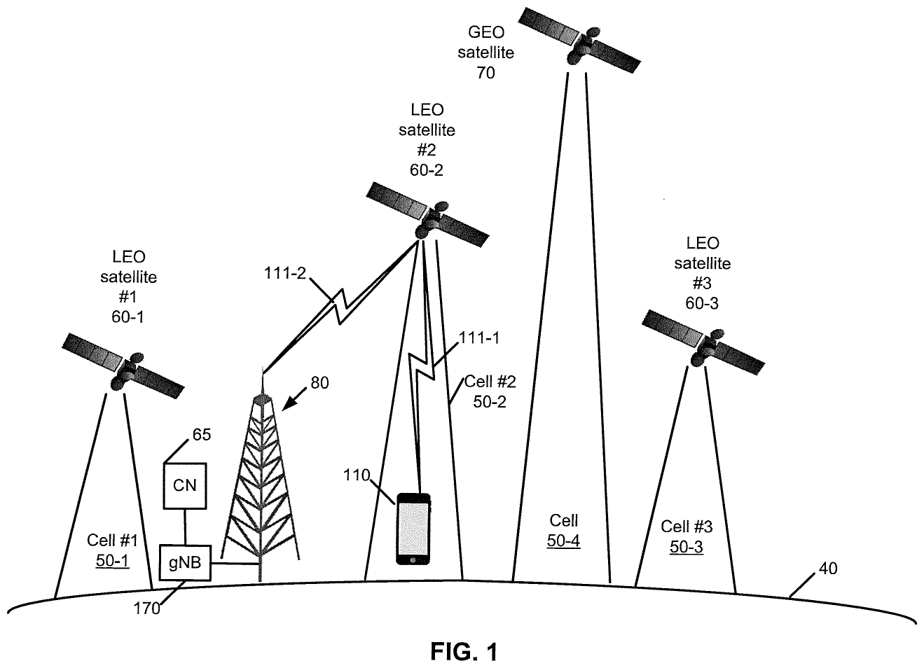

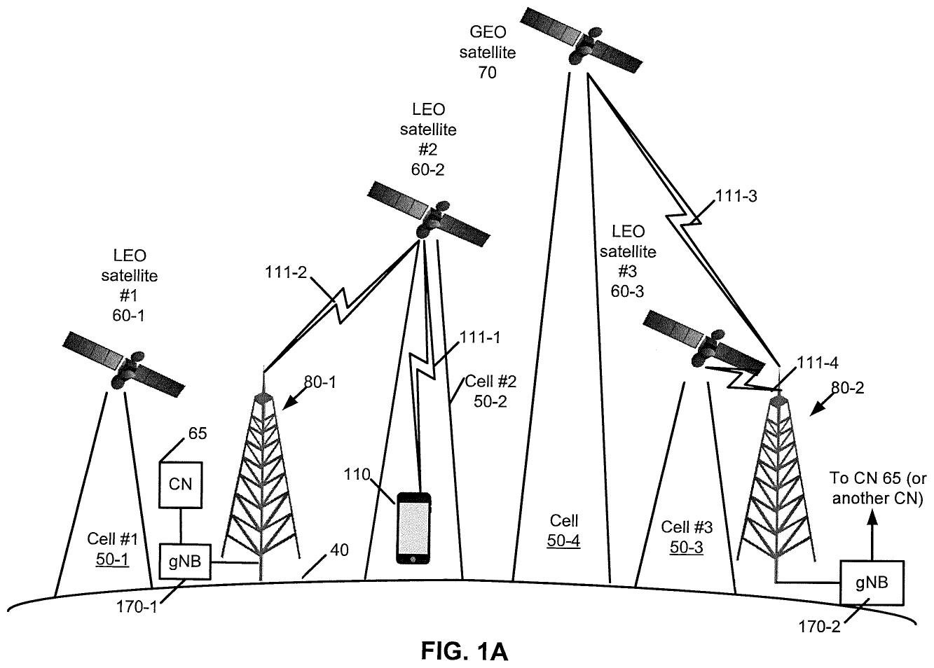

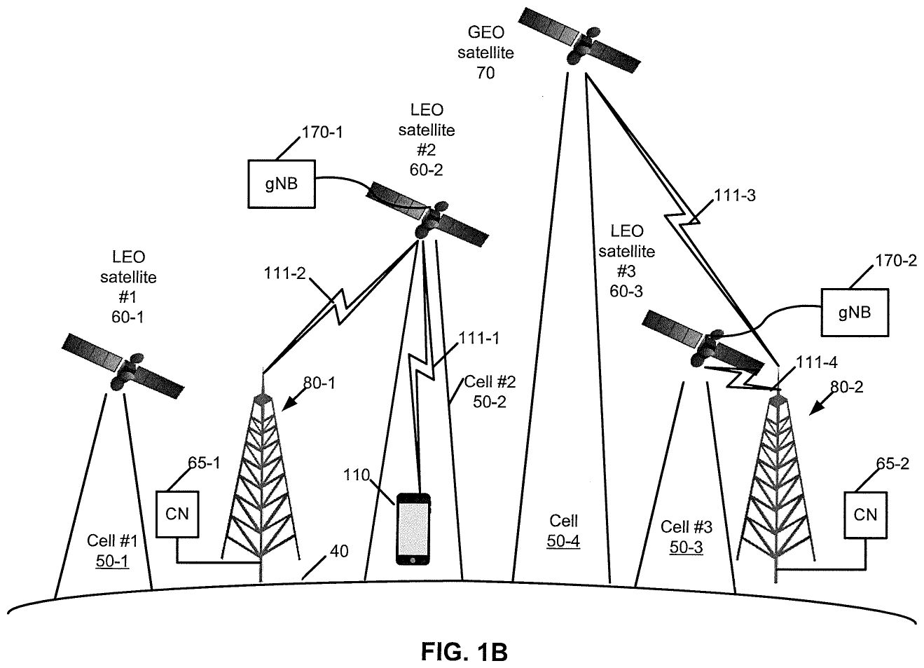

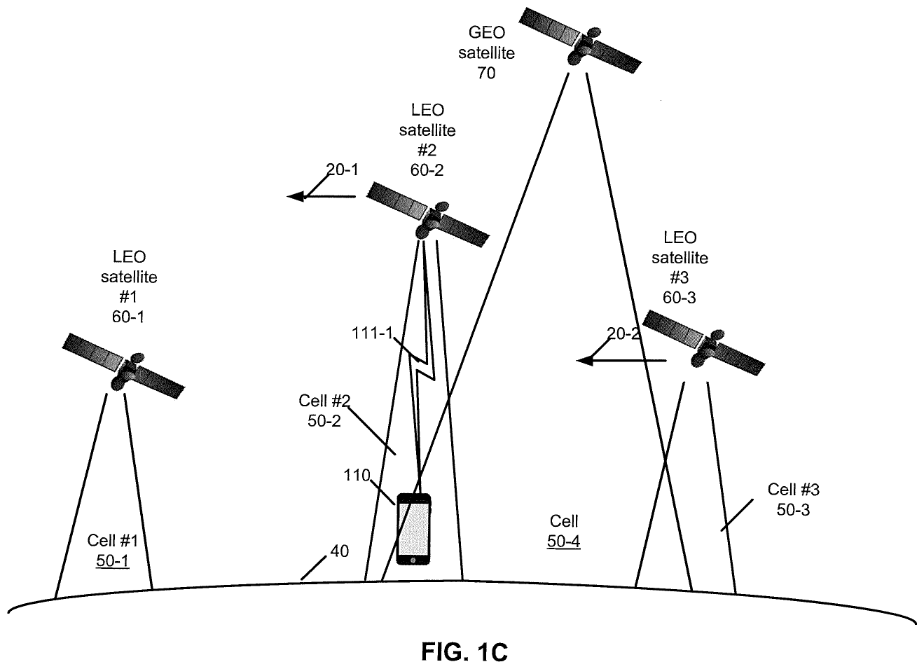

Turning to FIG. 1, this figure shows a diagram of one possible and non-limiting exemplary system in which the exemplary embodiments may be practiced. The system in FIG. 1 has three LEO satellites #1 60-1, #2 60-2, and #3 60-3, each of them creating a corresponding cell 50-1, 50-2, 50-3. The LEO satellites are examples of NGSOs that might be used. There is a GEO satellite 70 that creates its own cell 50-4, and this cell is considered to be fixed with respect to earth (i.e., geostationary). The horizon 40 of the earth is shown. A UE 110 is shown communicating via radio link 111-1 with LEO satellite #2, 60-2, and then through the LEO satellite 60-2 via link 111-2 to the satellite gateway 80 and then to gNB 170. The LEO satellites 60 move at a relatively high rate of speed with respect to earth, and this effect is described more below. Briefly, each cell 50-1, 50-2, and 50-3 is considered to be fixed with respect to earth for some time period, after which the cell is deactivated, as the corresponding LEO satellite's position moves such that the cell can no longer be maintained. What was just described is earth-fixed cells, and the primary emphasis herein is placed on this structure. The exemplary embodiments may, however, also be applied to earth-moving cells, where the cells move with the satellites and the cells move across the surface of earth with the speed of the satellite movement.

The gNB 170 is connected to a core network (CN) 65. The CN 65 could be a 5GC (5G core network) or LTE core network.

The UE is a wireless, typically mobile device that can access a wireless network such as a cellular system. The UE may also be fixed, however. The gNB 170 is a base station that provides access by wireless devices such as the UE 110 to a wireless network such as a cellular network. The gNB 170 may be, for instance, a base station for 5G, also called New Radio (NR). The gNB 170 may also be an eNB (evolved NodeB) base station, for LTE (long term evolution), or any other suitable base station. The UE 110 may communicate via a LEO satellite 60 or GEO satellite 70 to the gNB 170.

FIGS. 1A and 1B illustrate additional possible configurations for FIG. 1. FIG. 1C illustrates a further configuration, but this is described below after description of FIGS. 1A, 1B, and 1D. In FIG. 1A, there are two satellite gateways 80-1 and 80-2, each coupled to a different gNB 170-1, 170-2, and the GEO satellite 70 communicates with the satellite gateway 80-2 and gNB 170-2 via radio link 111-3. The LEO satellite #3 60-3 communicates with the satellite gateway 80-2 via radio link 111-4, while the LEO satellite #2 60-2 communicates with the satellite gateway 80-1 via radio link 111-2. The two gNBs 170-1, 170-2 may communicate to the same or different core networks 65. Alternatively, the GEO satellite 70 may communicate with the satellite gateway 80-1.

In FIG. 1B, this is an illustration of a regenerative architecture. In this situation, the gNBs 170-1 and 170-2 are located on corresponding LEO satellites #2 60-2 and #3 60-3, respectively. The satellite gateways 80-1 and 80-2 are used to communicate with a core network, and in this example, there are two separate core networks CN 65-1 and 65-2, though there could be a single CN or more CNs.

Turning to FIG. 1D, this figure illustrates an apparatus that may be used for any of the entities in FIG. 1. Apparatus 10 may be used in any of the UE 110, gNB 70, LEO satellites 60, and GEO satellite 70. The apparatus 10 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more antennas 128 may communicate via wireless links 111.

The one or more memories 125 include computer program code 123. The apparatus 10 includes a control module 140, comprising one of or both parts 140-1 and/or 140-2, which may be implemented in a number of ways. The control module 140 may be implemented in hardware as control module 140-1, such as being implemented as part of the one or more processors 120. The control module 140-1 may be implemented also as an integrated circuit or through other hardware such as a programmable gate array. In another example, the control module 140 may be implemented as control module 140-2, which is implemented as computer program code 123 and is executed by the one or more processors 120. For instance, the one or more memories 125 and the computer program code 123 may be configured to, with the one or more processors 120, cause the apparatus 10 to perform one or more of the operations as described herein.

The computer readable memories 125 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 125, 155, and 171 may be means for performing storage functions. The processors 120 may be of any type suitable to the local technical environment, and may include one or more of general-purpose computers, special purpose computers, microprocessors, digital signal processors (DSPs) and processors based on a multi-core processor architecture, as non-limiting examples. The processors 120 may be means for performing functions, such as controlling the UE 110, gNB 170, LEO satellite 60, and GEO satellite 70, and other functions as described herein.

In general, the various embodiments of the user equipment 110 can include, but are not limited to, cellular telephones (such as smart phones, mobile phones, cellular phones, voice over Internet Protocol (IP) (VOIP) phones, and/or wireless local loop phones), tablets, portable computers, vehicles or vehicle-mounted devices for, e.g., wireless V2X (vehicle-to-everything) communication, image capture devices such as digital cameras, gaming devices, music storage and playback appliances, Internet appliances (including Internet of Things, IoT, devices), IoT devices with sensors and/or actuators for, e.g., automation applications, as well as portable units or terminals that incorporate combinations of such functions, laptop-embedded equipment (LEE), laptop-mounted equipment (LME), Universal Serial Bus (USB) dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. That is, the UE 110 could be any end device that may be capable of wireless communication. By way of example rather than limitation, the UE may also be referred to as a communication device, terminal device (MT), a Subscriber Station (SS), a Portable Subscriber Station, a Mobile Station (MS), or an Access Terminal (AT).

Having thus introduced one suitable but non-limiting technical context for the practice of the exemplary embodiments, the exemplary embodiments will now be described with greater specificity.

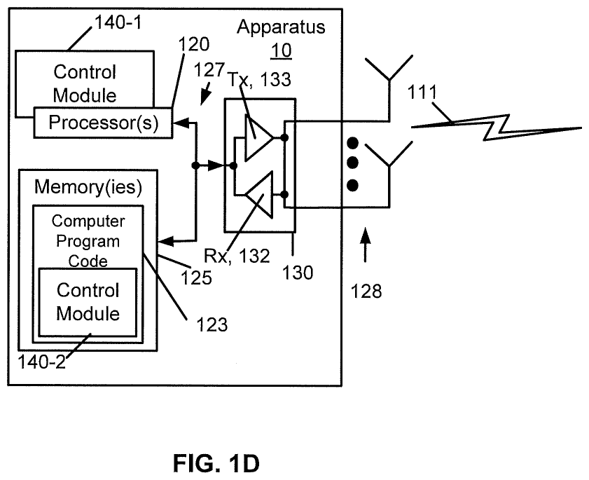

As stated above, the biggest challenge with GEO satellites is the distance from earth (approx. 36000 km), leading to large delays and a poor link budget. FIG. 2 helps to describe this. FIG. 2 is referred to as Table 1, and illustrates achievable throughput for a handheld UE in uplink and downlink at 2 GHz for GEO and LEO at 600 km. Table 1 shows the throughputs which can be achieved in LOS (line of sight) at an elevation angle of 30 degrees at the cell edge. It can be seen that the uplink is most challenging, caused by the limited UE power. Reaching a GEO satellite with a handheld is not possible with the assumptions used (this is based on the link budget in 3GPP TS 38.811) in the table.

At the same time, it can be seen that the uplink in LEO is also challenging. Regardless, a LEO satellite at 600 km can be reached and a throughput of 90 kbps in UL can be achieved.

There are several other challenges regarding the LEO satellites. Most of them are related to the fact that the satellites are moving quickly (e.g., 7.5 km/s) relative to earth. This means the coverage on earth is changing with the movement of the satellite. This leads, for example, to a UE needing to handover or reselect new cells almost continuously even if the UE is not moving, which comes at the cost of higher power consumption. Many use cases also expect a sparse array (e.g., a constellation of satellites being deployed). In such cases, the UEs may not be reachable by the constellation more than a few times a day, for the duration of a few minutes each time.

The procedure for an out-of-coverage UE is, according to its own frequency capabilities, altogether with the information pre-stored on the SIM card, to scan all RF channels in order to find a suitable network to camp on. This procedure can be very consuming in terms of timing and energy points of view. In particular, for modern UEs, which have multi-band capabilities, and have to scan a wide range of frequencies. 3GPP TS 38.304 says the following on PLMN scanning:

“The UE shall scan all RF channels in the NR bands according to its capabilities to find available PLMNs and available CAGs. On each carrier, the UE shall search for the strongest cell and read its system information, in order to find out which PLMN(s) the cell belongs to and any associated CAG(s)”

“The UE may optimise PLMN search by using stored information e.g., frequencies and optionally also information on cell parameters from previously received measurement control information elements”

However, if the UE is in a region where there is no coverage, because of the lack of support by terrestrial networks, and the sparse deployments of satellites, the UE will exhaustively search for a network to camp on, causing a massive drain on the battery, which points back to the problem raised previously.

There are different ideas to minimize the searching time, such as backoff timers before a new search and one cell informing the possible coverage times of next cells in the same network.

As can be seen in FIG. 1, if the UE 110 moves from left to right, the UE 110 would move from cell #1 into an area with no signal, into and through cell #2, and again into an area with no signal. This is discontinuous coverage.

Note that UE movement is not needed, though, as the satellites and their corresponding cells move. In particular, the LEO satellites at least would move faster (e.g., 7.5 km/s) than a UE might move. Consider FIG. 1C, which is a version of FIG. 1 that has been limited to concentrate on the cells. In this example, cell 50-4 is larger than what was shown in FIG. 1 and is fixed (the GEO satellite 70 does not move relative to earth). Meanwhile, the LEO satellite #2 60-2 moves in direction 20-1 and the LEO satellite #3 60-3 moves in direction 20-2, and both of these are moving relatively quickly (e.g., 7.5 km/s). Assuming there is no cell coverage between the satellites 60-2 and 60-3, the UE has discontinuous coverage for the LEO satellites, though could have coverage through the GEO satellite 70 in this specific example. If the cell 50-4 from the GEO satellite was smaller, as in FIG. 1, then there would be no coverage there either. This LEO satellite example, which is an earth-fixed cells example where the satellite moves but the locations of the cells are fixed, can be extended to earth-moving cells, where the satellites are moving as are their corresponding cells.

One exemplary issue is that with discontinuous coverage (due to too few satellites), a UE may be searching for a new cell (i.e., as the old cell disappeared with the satellite), while there is no satellite available for some time. This will lead to the UE using a lot of unnecessary power for searching for something which is not there, at least when the UE is in an area with no signal.

An overview of the exemplary embodiments is now provided, and more details are provided below. As an overview, exemplary embodiments enable a service that combines advantages of two systems. Consider the example of a system where a service provider with support via LEO satellite and GEO satellite access may provide coverage information (also referred to as assistance information) for UEs subscribing to different service providers (e.g., in another system) with LEO-only capabilities. Although LEO satellites are mainly used herein, the techniques may be extended to other NGSOs (non-geostationary objects). An exemplary solution is described in the next paragraphs.

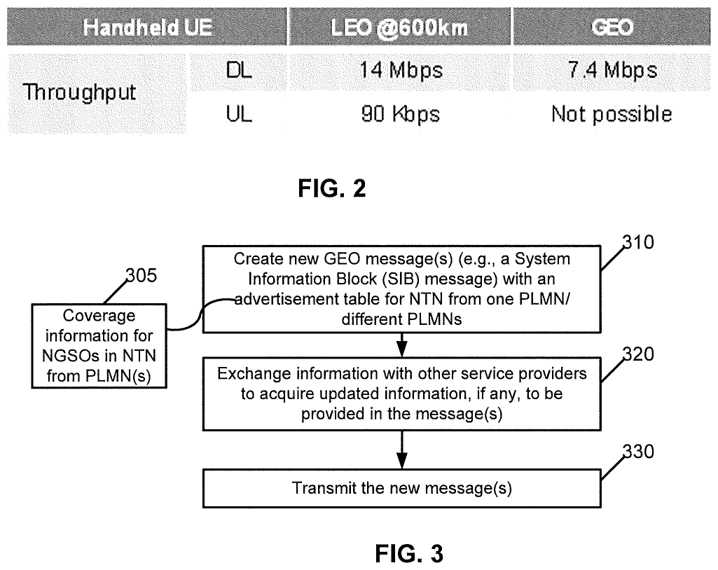

On the network side, the following may occur for this example. This is illustrated in part by FIG. 3, which is a logic flow diagram performed by a network for GEO guidance for LEO coverage and connectivity, in accordance with an exemplary embodiment. FIG. 3 illustrates the operation of an exemplary method, a result of execution of computer program instructions embodied on a computer readable memory, functions performed by logic implemented in hardware, and/or interconnected means for performing functions in accordance with an exemplary embodiment. This information would come from the respective satellite control centers to which each network is interfacing. If it is automated, the information would come from one of the units in the core network 80. Regardless of origination, there is an information exchange between the networks, like for instance facilitated by a core network unit. The logic flow includes the following.

1) Create new GEO message(s) (e.g., a System Information Block (SIB) message) with an advertisement table for NTN from one PLMN or different PLMNs. See block 310. The term “new” means new relative to what is currently being used. The advertisement table 305 comprises coverage information for NGSOs in NTN from PLMN(s).

a) The SIB may contain detailed information, to optimize the cell search (as described in detail below).

b) It is noted that the term “SIB” is used for this message/these messages, even though this term provides information for another system, so the naming can be different. However, the signaling is based on similar principles as a normal SIB, which is broadcast within the GEO cell area. This SIB is referred to herein as a LEO advertisement SIB, to distinguish over the currently used SIB.

2) Exchange information with other service providers to acquire updated information, if any, to be provided in the new message(s), e.g., the LEO advertisement SIB. See block 320.

3) Transmit the new message(s), e.g., the LEO advertisement SIB. See block 330. This information transmitted between networks could be exchanged in many different ways (e.g., emails, letters, or any other electronic communication, e.g., automated between the networks).

On the UE side, the following is assumed and is a broad characterization of an exemplary embodiment. The UE may not technically be “camped” on the GEO cell, but can receive information (e.g., the LEO advertisement SIB) from the GEO system. The UE instead may be camped on a LEO system but is without coverage. The UE wakes up as per the information from the GEO satellite (e.g., in the LEO advertisement SIB) and searches the LEO system, to possibly find a different LEO system to which the UE can attach.

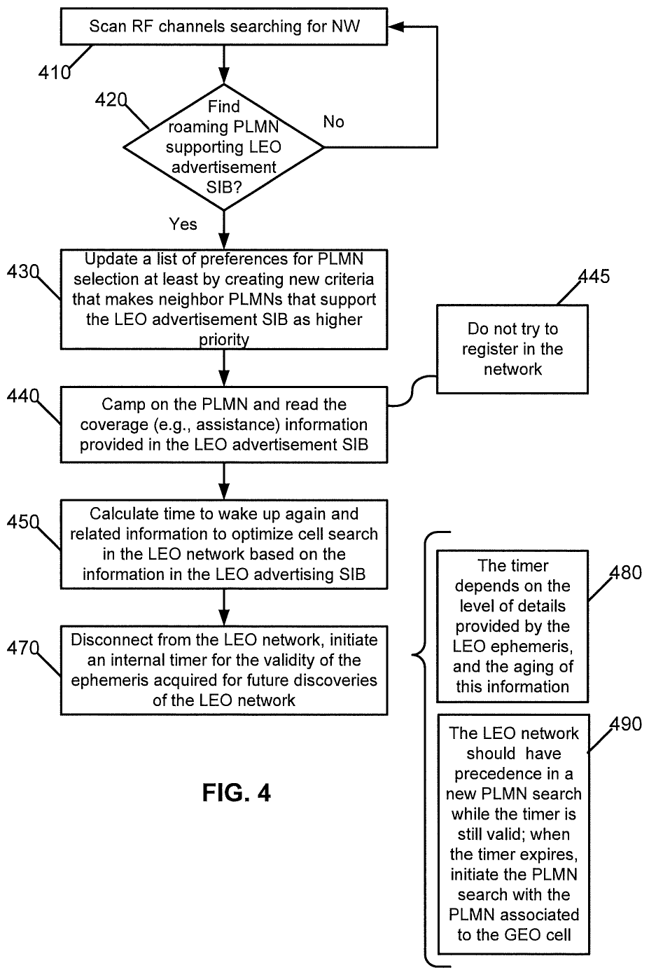

With this in mind, FIG. 4 is a logic flow diagram performed by a UE for GEO guidance for LEO coverage and connectivity, in accordance with an exemplary embodiment. FIG. 4 also illustrates the operation of an exemplary method, a result of execution of computer program instructions embodied on a computer readable memory, functions performed by logic implemented in hardware, and/or interconnected means for performing functions in accordance with an exemplary embodiment. The UE 110, under control of the control module 140, performs the operations in the blocks of FIG. 4.

Initially, the UE scans the RF channels searching for a network. See block 410. For the example of FIG. 4, if the UE cannot find a roaming PLMN supporting LEO advertisement SIB (block 420=No), the flow is assumed to proceed to block 410. However, the UE could contact the HPLMN or EHPLMN, but this is not shown. If the UE cannot find a HPLMN or a EHPLMN, but can find (block 420) a roaming PLMN that supports the LEO advertisement SIB (GEO cell) (block 420=Yes), the following are performed.

1) The UE updates the list of preferences for PLMN selection, e.g., as provided in 3GPP TS 23.122, at least by creating new criteria that makes neighbor PLMNs that support the LEO advertisement SIB as higher priority relative to PLMNs that do not support the LEO advertisement SIB. See block 430.

2) The UE camps on the PLMN and reads the coverage information (also called assistance information) provided in the LEO advertisement SIB from the GEO system. See block 440. As described above, for a GEO cell for this PLMN, this may not technically be “camping” on the cell, although the UE can receive information from the GEO cell. The information is referred to as “coverage” information, as the information allows determination of coverage for LEO satellites. This information may also be considered to assist with cell searching and selection and may therefore considered to be assistance information. The UE may be camped on a LEO system for this PLMN but is without coverage. The UE does not try to register in the network (see block 445). That is, the legacy procedures mandating registration (and associated counters, log of failures, and the like) causes are bypassed instead.

3) The UE calculates the best time to wake up again and the related information to optimize cell search in the LEO network based on the information in the LEO advertising SIB. See block 450. In an example, a “best time” is a best time from a UE power consumption, throughput, and/or QoS point of view. An optimized cell search is optimized for a UE power consumption point of view. That is, for the best time and the optimized cell search, the UE performs an analysis or analyses for these and selects a best time based on the analyses and related information for an optimized cell search based on the analyses. The related information may be frequency, PCI (physical cell identifier), expected Doppler, and/or timing among other information.

4) After the UE disconnects from the LEO network, the UE initiates an internal timer for the validity of the ephemeris acquired for future discoveries of the LEO network. See block 470. Additional possible details are as described in the examples (a) and (b) below.

a) The timer depends on the level of details provided by the LEO ephemeris, and the aging of this information. See block 480.

b) The LEO network should have precedence in a new PLMN search while the timer is still valid. When the timer expires, the UE should initiate the PLMN search with the PLMN associated to the GEO cell. See block 490. This is more stable in continuity, time and frequency offsets, as there is always coverage compared to LEO where the coverage comes and goes (as described above).

Exemplary embodiments may be implemented in different manners. Details are now provided on two possible implementations that cover multiple scenarios. Two exemplary implementations are described, although these are not considered to be limiting.

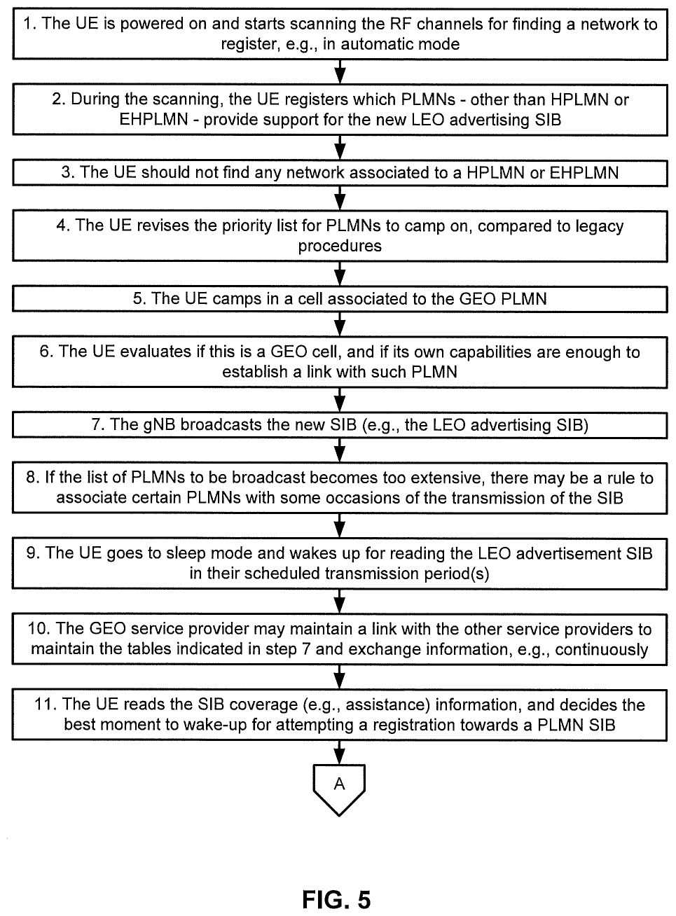

A first implementation is now described. The scenario for the first implementation and the related actions by UE and NW are described below. The first implementation is described by reference to FIG. 5, which is a logic flow diagram performed by a UE and a network for GEO guidance for LEO coverage and connectivity, in accordance with an exemplary embodiment. FIG. 5 is a list of possible actions taken by various entities in the first implementation. FIG. 5 also illustrates the operation of an exemplary method, a result of execution of computer program instructions embodied on a computer readable memory, functions performed by logic implemented in hardware, and/or interconnected means for performing functions in accordance with an exemplary embodiment. For ease of reference, these steps also use a multilevel list.

1. The UE is powered on and starts scanning the RF channels for finding a Network to register, e.g., in automatic mode.

2. During the scanning, UE registers which PLMNs—other than HPLMN or EHPLMN-provide support for the new LEO advertising SIB.

3. UE should not find any network associated to a HPLMN or EHPLMN.

4. The UE revises the priority list for PLMNs to camp on, compared to legacy procedures.

A note about the current legacy procedures. The current list of priorities in legacy procedures are specified as follows (3GPP TS 23.122), between opening and closing double quotation marks:

“The MS selects and attempts registration on other PLMN/access technology combinations, if available and allowable, in the following order:
i) either the HPLMN (if the EHPLMN list is not present or is empty) or the highest priority EHPLMN that is available (if the EHPLMN list is present);
ii) each PLMN/access technology combination in the ‘User Controlled PLMN Selector with Access Technology’ data file in the SIM (in priority order);
iii) each PLMN/access technology combination in the ‘Operator Controlled PLMN Selector with Access Technology’ data file in the SIM (in priority order) or stored in the ME (in priority order);
iv) other PLMN/access technology combinations with received high quality signal in random order;
v) other PLMN/access technology combinations in order of decreasing signal quality.”

For step (4), these are possible sub-steps:
a) The UE moves the PLMNs with support of the new LEO advertising SIB up in the list of priorities.
b) Whether the GEO PLMN-used for assistance only-should precede other LEO systems that could be used as VPLMNs (but with high charging rates) can be presented as an option to the UE.

5. The UE camps in a cell associated to the GEO PLMN. This example uses a GEO cell, but the UE may not technically “camp” on the cell, as described below.

6. The UE evaluates if this is a GEO cell, and if its own capabilities (for example UL EIRP) are enough to establish a link with such PLMN. If the UE's own capabilities are not enough to establish a link with the PLMN, the UE does not proceed with the common procedures for a UE in DEREGISTERED state or a UE in no-cells-suitable substate. A new state may be created, instead, to support this operation. The new state could be similar to idle mode (where a UE is camped on a cell), except that the UE is not registered to that network, and the UE is instead listening to the relevant SIBs (e.g., within the advertising window) without “camping” on the cell. The UE performs actions with respect to step 7 and other steps described below.

It is noted that if this is a GEO cell and if the UE's capabilities are enough to establish a link, the UE can in principle just use the GEO satellite for its communication. However, the UE could also benefit from a LEO satellite and get higher throughput, so the UE may not establish a link to the GEO cell and instead perform actions with respect to step 7 and other steps described below.

7. The gNB broadcasts the new SIB (e.g., the LEO advertising SIB). Note the UE will also receive the broadcast.

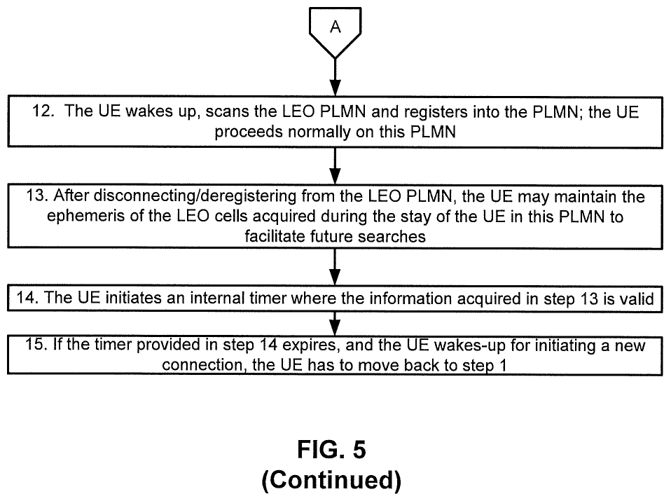

a. The information provided in the new LEO advertising SIB may encompass a table with the information shown in FIG. 6, which illustrates a timetable with next LEO coverage times and probabilities.
i. A time window where LEO/MEO satellites will be available in the area of the current GEO cell;
ii. The PLMN(s) associated to the LEO/MEO satellites provided in 7.a.i.
A. Additionally, a list of available cells can be provided as well, such the UE also knows which cells are available during the coverage likelihood.
B. In an alternative implementation the available cells are shown first followed by the different PLMNs they support.
iii. The frequency channel(s) available in the LEO/MEO satellite.
iv. The coverage likelihood (which may be calculated as the overlap between the coverage area of the current GEO cell and the satellite coverage area of the incoming satellite), indicating how likely it is to get connectivity from the LEO satellite in the current GEO cell.
v. A list with optional information:
A. A list of PLMNs that maintain roaming agreements for LEO with the PLMN indicated in 7.a.ii.
B. Ephemeris information of the satellite.
C. Beam polarization.
D. Doppler pre-compensation used in the satellite.
E. Available PCIs.

8. If the list of PLMNs to be broadcast becomes too extensive (for example broadcasting all satellites over a period of 24 hours, passing by a large region, for several different PLMNs), there may be a rule to associate certain PLMNs with some occasions of the transmission of the LEO advertising SIB.

a. For example: In one occasion, the LEO advertising SIB carries only even-numbered PLMNs, whereas odd-numbered PLMNs are carried in the next transmission of the LEO advertising SIB.

b. The rule above may be based, for example, on a modulo operation.

c. This rule may be hard-coded in specifications or be flexible for NW implementation.

d. This rule may be indicated in SIB1 or in the new LEO advertisement SIB.

9. The UE goes to sleep mode and wakes up for reading the LEO

advertisement SIB in their scheduled transmission period(s). The UE may also consider step 8 to skip the reception of a few transmissions of the new LEO advertisement SIB.

10. The GEO service provider may maintain a link with the other service providers to maintain the tables indicated in step 7 and exchange information, e.g., continuously.

11. The UE reads the SIB coverage (e.g., assistance) information, and decides the best moment to wake-up for attempting a registration towards a PLMN SIB in the LEO advertising SIB.

a. The UE may try to maximize battery savings, and skip time windows where the likelihood of coverage is too low.

b. The UE may choose to wake-up to a VPLMN instead of waiting too long for a HPLMN. Charging policies and service requirements may be taken into consideration, as well as user inputs.

12. The UE wakes up, scans the LEO PLMN and registers into the PLMN. The UE proceeds normally on this PLMN.

13. After disconnecting/deregistering from the LEO PLMN, the UE may maintain the ephemeris of the LEO cells acquired during the stay of the UE in this PLMN to facilitate future searches.

14. The UE initiates an internal timer where the information acquired in step 13 is valid (the ephemeris may not be enough to calculate a future connection in 48 hours, for example).

15. If the timer provided in step 14 expires, and the UE wakes-up for initiating a new connection, the UE has to move back to step 1. The UE moves the GEO PLMN and associated frequency channel to the top of the search list. The UE may skip directly to step 5 after finding the GEO system and camp directly to it. This facilitates the search procedure as GEO cells are more stable (e.g., in frequency, time, and/or service continuity).

It should be noted that if the UE does not find a relevant PLMN on the list provided in step 7, the UE may try different GEO satellites, if available among the ones discovered in step 2.

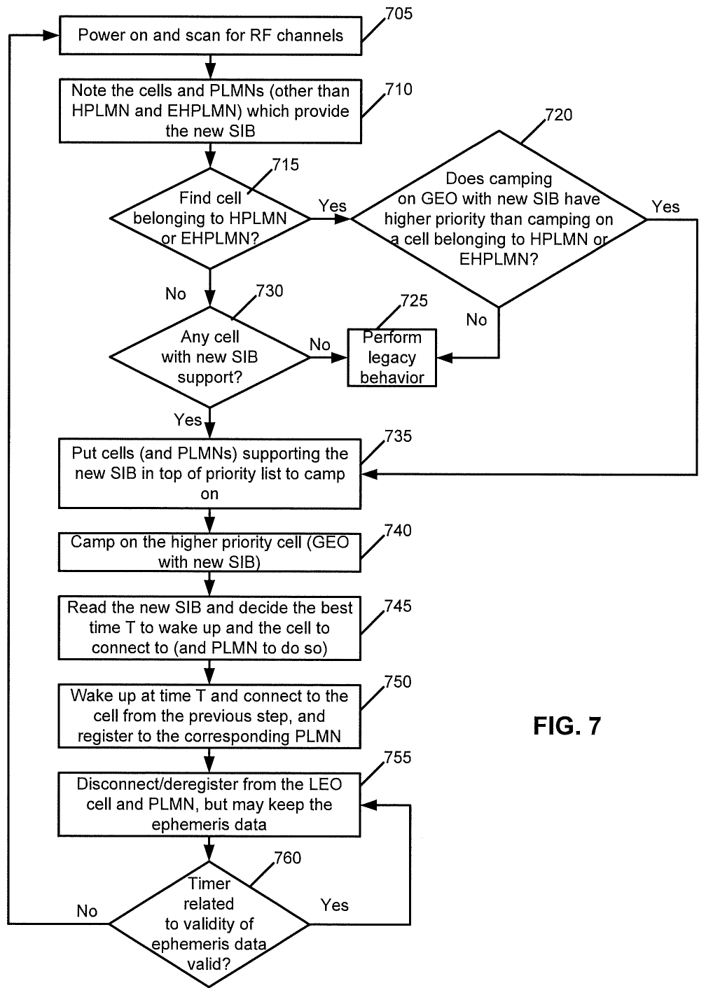

Turning to FIG. 7, this figure is a logic flow diagram performed by a UE for GEO guidance for LEO coverage and connectivity, in accordance with the first exemplary implementation. FIG. 6 also illustrates the operation of an exemplary method, a result of execution of computer program instructions embodied on a computer readable memory, functions performed by logic implemented in hardware, and/or interconnected means for performing functions in accordance with an exemplary embodiment. The operations in the blocks in FIG. 7 are assumed to be performed by a UE 110 under control of the control module 140.

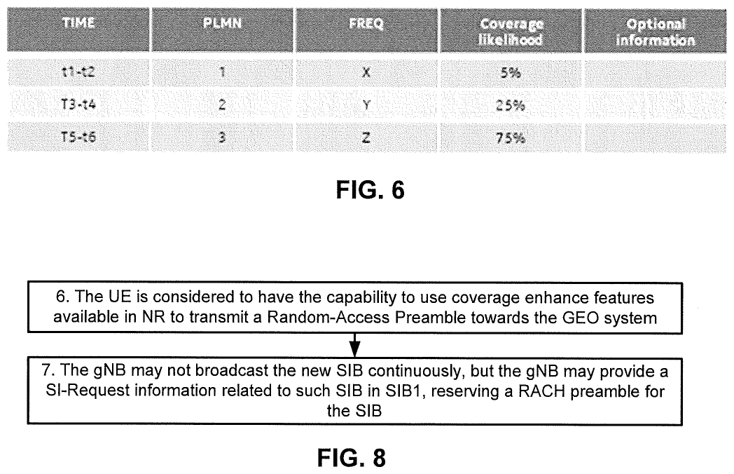

The first exemplary implementation has been described. A second exemplary implementation is now described. The second exemplary implementation is described using FIG. 8, which is part of a logic flow diagram performed by a UE and a network for GEO guidance for LEO coverage and connectivity. The steps of FIG. 5 are assumed to be used, too, although only the different steps are shown in FIG. 8.

In block 705, the UE powers on and scans RF channels. The UE in block 710 notes the cells and PLMNs (other than HPLMN and EHPLMN) which provide the new SIB. In this example, the LEO advertising SIB is referred to as the “new SIB”. In block 715, the UE determines whether it finds a cell belonging to HPLMN or EHPLMN. If so (block 715=Yes), the UE in block 720 determines whether camping on a GEO cell with the new SIB has a higher priority than camping on a cell belonging to HPLMN or EHPLMN. If so (block 720=Yes), the flow proceeds to block 735.

If the UE does not find a cell belonging to HPLMN or EHPLMN (block 715=No), the UE determines in block 730 whether there is any cell with new SIB support. If not, legacy behavior is performed by the UE in block 725. Block 725 may also be reached if the camping on GEO with the new SIB does not have a higher priority than camping on a cell belonging to HPLMN or EHPLMN (block 720=NO).

If the UE does find a cell belonging to HPLMN or EHPLMN (block 715=Yes), the UE in block 735 puts cells (and PLMNs) supporting the new SIB in top of its priority list to camp on. As described previously, block 735 may also be reached by block 720.

In block 740, the UE camps on the higher priority cell (e.g., a GEO with new SIB). As described above, this “camping” for a GEO cell may mean the UE can read information from the GEO cell, but may not technically be “camped” on the cell. The UE may be camped on a LEO system but may be without coverage. The UE reads the new SIB and decides the best time T to wake up and the cell to connect to after waking (and PLMN to do so). See block 745. The best time in this example depends on a combination of availability (e.g., the LEO system needs to be available), the amount of data to be transmitted (e.g., more data, then the UE should start right away when the cell is available whereas with little data the UE could potentially wait until the best throughput can be achieved). The UE wakes up at time T and connects to the cell from the previous step, and registers to the corresponding PLMN. See block 750.

In block 755, the UE disconnects/deregisters from the LEO cell and PLMN, but may keep the ephemeris data. In block 760, the UE determines whether a timer related to validity of the ephemeris data is valid. For instance, if the ephemeris data includes X, the timer is set to A, but if the ephemeris data includes Y, the timer is set to B. It is also possible that the timer is “fixed” after disconnection, e.g., the timer is set for a fixed time after the disconnection is performed. If the timer is valid (block 755=Yes), the flow proceeds back to block 755. If not (block 760=No), the flow proceeds back to block 705.

The second implementation of the solution is very similar to the first, except for two differences, described as follows.

For step 6, the UE is considered to have the capability to use coverage enhance features available in NR to transmit a Random-Access Preamble (for example, using repetitions) towards the GEO system.

For step 7, the gNB may not broadcast the new LEO advertisement SIB continuously. But the gNB may provide a SI-Request information related to such SIB in SIB1, reserving a RACH preamble for the LEO advertising SIB.

In this case, after camping on the GEO cell, the UE may send a SI-Request, via RACH preamble reserved resources, requiring the transmission of the new LEO advertising SIB.

Additional exemplary parts to the second implementation may include the following.

1) There may be a rule indicating which RACH occasions can be used for accessing information from different PLMNs. Examples:
a) SFN XX32 can be used for PLMNs ending in 32, and the like; and/or
b) The X-th RACH occasion, counted from SFN 0, can be used for a certain subset of PLMNs.

2) The UE selects a RACH occasion/resource according to this rule.

3) The GEO operator, by knowing the subset of PLMNs the UE is interested in, may pre-emptively send a “heads-up message” for the service providers the operator has agreements with. The target systems will know that a UE in a given area, that may belong to this PLMN, may require connectivity. It can trigger enhanced-aid from the target LEO system when flying by this area (for example: wake-up signals)

Without in any way limiting the scope, interpretation, or application of the claims appearing below, a technical effect and advantage of one or more of the example embodiments disclosed herein is the exemplary embodiments minimize considerably the search time of LEO UEs in sparse deployments when a GEO system is available. Another technical effect and advantage of one or more of the example embodiments disclosed herein is enables a GEO service that can be made available for all NTN operators through agreements with the GEO service provider.

The following are additional examples.

Example 1. A method, comprising:
creating one or more messages to be transmitted over a geostationary system, the one or more messages comprising coverage information for one or more non-geostationary satellites in a non-terrestrial network from one or more public land mobile networks; and
transmitting over the geostationary system the one or more messages.

Example 2. The method according to example 1, wherein the creating and transmitting are performed by a service provider, and wherein the method further comprises, prior to the transmitting, exchanging information with other service providers to acquire updated information, if any, to be provided in the one or more messages.

Example 3. A method, comprising:
searching, by a user equipment, for a public land mobile network;
in response to finding a public land mobile network transmitting, using a geostationary system, one or more messages comprising coverage information for one or more non-geostationary satellites in a non-terrestrial network, receiving by the user equipment the one or messages;
updating by the user equipment preferences used for a list used for public land mobile network selection to make one or more public land mobile networks corresponding to the coverage information as higher priority than other public land mobile networks in the list; and
performing by the user equipment one or more cell searches for cells from the one or more non-geostationary satellites using the updated list.

Example 4. The method according to example 3, wherein the searching for a public land mobile network further comprises scanning, by the user equipment while listening to the geostationary system, radio frequency channels to search for a network, and the receiving is performed in response to finding the public land mobile network transmitting the one or more messages while performing the scanning.

Example 5. The method according to any one of examples 3 or 4, further comprising listening by the user equipment to a public land mobile network based on priorities in the list, but where the user equipment does not try to register or register in the public land mobile network to which the user equipment is listening.

Example 6. The method according to any one of examples 3 to 5, wherein the performing one or more cell searches comprises determining a time to wake up again and related coverage information to perform a next cell search in the non-terrestrial network based on the coverage information, the related coverage information comprising a cell and a corresponding public land mobile network in the non-terrestrial network to which to search.

Example 7. The method according to example 6, further comprising, after the time to wake up again, registering with the public land mobile network in the related coverage information, and connecting to the cell for the public land mobile network in the related coverage information.

Example 8. The method according to example 7, further comprising, after the user equipment disconnects from the non-terrestrial network, initiating by the user equipment a timer for validity of ephemeris acquired for future discoveries of the non-terrestrial network, wherein the non-terrestrial network in the related coverage information has precedence in a new public land mobile network search while the timer is still valid, but in response to the timer expiring, initiating public land mobile network search with the public land mobile network associated to the geostationary system instead of with the non-terrestrial network in the related coverage information.

Example 9. The method according to one of examples 1 to 8, wherein the one or more messages are system information block messages.

Example 10. The method according to one of examples 1 to 9, wherein the coverage information contains information for cell searches to be performed in the non-terrestrial network by the user equipment.

Example 11. The method according to example 10, wherein the information for the cell searches comprises one of more of the following:
a time window where the one or more non-geostationary satellites will be available in the area of a current geostationary cell in the geostationary system;
the one or more public land mobile networks associated to the one or more non-geostationary satellites;
one or more frequency channels available in the one or more non-geostationary satellites; or
a coverage likelihood indicating how likely it is to get connectivity from the one or more non-geostationary satellites in the current geostationary cell.

Example 12. The method according to one of examples 10 or 11, wherein the information for the cell searches comprises a list comprising one or more of the following:
a. a further list of public land mobile networks that maintain roaming agreements for the one or more non-geostationary satellites with the public land mobile network associated to the one or more non-geostationary satellites;
b. ephemeris information of the one or more non-geostationary satellites;
c. beam polarization for the one or more non-geostationary satellites;
d. doppler pre-compensation used in the one or more non-geostationary satellites; or
e. available physical cell identifiers for cells created by the one or more non-geostationary satellites.

Example 13. A computer program, comprising code for performing the methods of any of examples 1 to 12, when the computer program is run on a computer.

Example 14. The computer program according to example 13, wherein the computer program is a computer program product comprising a computer-readable medium bearing computer program code embodied therein for use with the computer.

Example 15. The computer program according to example 13, wherein the computer program is directly loadable into an internal memory of the computer.

Example 16. An apparatus, comprising means for performing:
creating one or more messages to be transmitted over a geostationary system, the one or more messages comprising coverage information for one or more non-geostationary satellites in a non-terrestrial network from one or more public land mobile networks; and
transmitting over the geostationary system the one or more messages.

Example 17. The apparatus according to example 16, wherein the creating and transmitting are performed by a service provider, and wherein the means are further configured to perform: prior to the transmitting, exchanging information with other service providers to acquire updated information, if any, to be provided in the one or more messages.

Example 18. An apparatus, comprising means for performing:
searching, by a user equipment, for a public land mobile network;
in response to finding a public land mobile network transmitting, using a geostationary system, one or more messages comprising coverage information for one or more non-geostationary satellites in a non-terrestrial network, receiving by the user equipment the one or messages;
updating by the user equipment preferences used for a list used for public land mobile network selection to make one or more public land mobile networks corresponding to the coverage information as higher priority than other public land mobile networks in the list; and
performing by the user equipment one or more cell searches for cells from the one or more non-geostationary satellites using the updated list.

Example 19. The apparatus according to example 18, wherein the searching for a public land mobile network further comprises scanning, by the user equipment while listening to the geostationary system, radio frequency channels to search for a network, and the receiving is performed in response to finding the public land mobile network transmitting the one or more messages while performing the scanning.

Example 20. The apparatus according to any one of examples 18 or 19, wherein the means are further configured to perform: listening by the user equipment to a public land mobile network based on priorities in the list, but where the user equipment does not try to register or register in the public land mobile network to which the user equipment is listening.

Example 21. The apparatus according to any one of examples 18 to 20, wherein the performing one or more cell searches comprises determining a time to wake up again and related coverage information to perform a next cell search in the non-terrestrial network based on the coverage information, the related coverage information comprising a cell and a corresponding public land mobile network in the non-terrestrial network to which to search.

Example 22. The apparatus according to example 21, wherein the means are further configured to perform: after the time to wake up again, registering with the public land mobile network in the related coverage information, and connecting to the cell for the public land mobile network in the related coverage information.

Example 23. The apparatus according to example 22, wherein the means are further configured to perform: after the user equipment disconnects from the non-terrestrial network, initiating by the user equipment a timer for validity of ephemeris acquired for future discoveries of the non-terrestrial network, wherein the non-terrestrial network in the related coverage information has precedence in a new public land mobile network search while the timer is still valid, but in response to the timer expiring, initiating public land mobile network search with the public land mobile network associated to the geostationary system instead of with the non-terrestrial network in the related coverage information.

Example 24. The apparatus according to one of examples 16 to 23, wherein the one or more messages are system information block messages.

Example 25. The apparatus according to one of examples 16 to 24, wherein the coverage information contains information for cell searches to be performed in the non-terrestrial network by the user equipment.

Example 26. The apparatus according to example 25, wherein the information for the cell searches comprises one of more of the following:
a time window where the one or more non-geostationary satellites will be available in the area of a current geostationary cell in the geostationary system;
the one or more public land mobile networks associated to the one or more non-geostationary satellites;
one or more frequency channels available in the one or more non-geostationary satellites; or
a coverage likelihood indicating how likely it is to get connectivity from the one or more non-geostationary satellites in the current geostationary cell.

Example 27. The apparatus according to one of examples 25 or 26, wherein the information for the cell searches comprises a list comprising one or more of the following:
a. a further list of public land mobile networks that maintain roaming agreements for the one or more non-geostationary satellites with the public land mobile network associated to the one or more non-geostationary satellites;
b. ephemeris information of the one or more non-geostationary satellites;
c. beam polarization for the one or more non-geostationary satellites;
d. doppler pre-compensation used in the one or more non-geostationary satellites; or
e. available physical cell identifiers for cells created by the one or more non-geostationary satellites.

Example 28. The apparatus of any preceding apparatus example, wherein the means comprises:
at least one processor; and
at least one memory including computer program code, the at least one memory and computer program code configured to, with the at least one processor, cause the performance of the apparatus.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
3GPP third generation partnership project
5G fifth generation
5GC 5G core network
AMF access and mobility management function
CAG Closed Access Group
CN core network
CU central unit
DL downlink (from network toward UE)
DU distributed unit
EIRP Effective Isotropic Radiated Power
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
EHPLMN equivalent home PLMN
gNB (or gNodeB) GEO geostationary base station for 5G/NR, i.e., a node providing NR user plane and control plane protocol terminations towards the UE, and connected via the NG interface to the 5GC
HPLMN home PLMN
I/F interface
LEO low-earth orbit
LOS line of sight
LTE long term evolution
MAC medium access control
MEO medium earth orbit
MME mobility management entity
ng or NG next generation
ng-eNB or NG-eNB next generation eNB
NGSO non-geostationary object
NR new radio
NTN non-terrestrial network
N/W or NW network
PCI physical cell identifier
PDCP packet data convergence protocol
PHY physical layer
PLMN Public Land Mobile Network
QOS quality of service
RAN radio access network
Rel release
RF radio frequency
RLC radio link control
RRH remote radio head
RRC radio resource control
RU radio unit
Rx receiver
SDAP service data adaptation protocol
SGW serving gateway
SI study item
SIB system information block
SMF session management function
TS technical specification
Tx transmitter
UE user equipment (e.g., a wireless, typically mobile device)
UL uplink (from UE toward network)
UPF user plane function
VPLMN visited PLMN
WI work item

1-2. (canceled)

3. A method, comprising:
searching, by a user equipment, for a public land mobile network;
in response to finding a public land mobile network transmitting, using a geostationary system, one or more messages comprising coverage information for one or more non-geostationary satellites in a non-terrestrial network, receiving by the user equipment the one or messages;
updating by the user equipment preferences used for a list used for public land mobile network selection to make one or more public land mobile networks corresponding to the coverage information as higher priority than other public land mobile networks in the list; and
performing by the user equipment one or more cell searches for cells from the one or more non-geostationary satellites using the updated list.

4. The method according to claim 3, wherein the searching for a public land mobile network further comprises scanning, by the user equipment while listening to the geostationary system, radio frequency channels to search for a network, and the receiving is performed in response to finding the public land mobile network transmitting the one or more messages while performing the scanning.

5. The method according to claim 3, further comprising listening by the user equipment to a public land mobile network based on priorities in the list, but where the user equipment does not try to register or register in the public land mobile network to which the user equipment is listening.

6. The method according to claim 3, wherein the performing one or more cell searches comprises determining a time to wake up again and related coverage information to perform a next cell search in the non-terrestrial network based on the coverage information, the related coverage information comprising a cell and a corresponding public land mobile network in the non-terrestrial network to which to search.

7. The method according to claim 6, further comprising, after the time to wake up again, registering with the public land mobile network in the related coverage information, and connecting to the cell for the public land mobile network in the related coverage information.

8. The method according to claim 7, further comprising, after the user equipment disconnects from the non-terrestrial network, initiating by the user equipment a timer for validity of ephemeris acquired for future discoveries of the non-terrestrial network, wherein the non-terrestrial network in the related coverage information has precedence in a new public land mobile network search while the timer is still valid, but in response to the timer expiring, initiating public land mobile network search with the public land mobile network associated to the geostationary system instead of with the non-terrestrial network in the related coverage information.

9. The method according to claim 3, wherein the one or more messages are system information block messages.

10. The method according to claim 3, wherein the coverage information contains information for cell searches to be performed in the non-terrestrial network by the user equipment.

11. The method according to claim 10, wherein the information for the cell searches comprises one of more of the following:
a time window where the one or more non-geostationary satellites will be available in the area of a current geostationary cell in the geostationary system;
the one or more public land mobile networks associated to the one or more non-geostationary satellites;
one or more frequency channels available in the one or more non-geostationary satellites; or
a coverage likelihood indicating how likely it is to get connectivity from the one or more non-geostationary satellites in the current geostationary cell.

12. The method according to claim 10, wherein the information for the cell searches comprises a list comprising one or more of the following:
a. a further list of public land mobile networks that maintain roaming agreements for the one or more non-geostationary satellites with the public land mobile network associated to the one or more non-geostationary satellites;
b. ephemeris information of the one or more non-geostationary satellites;
C. beam polarization for the one or more non-geostationary satellites;
d. doppler pre-compensation used in the one or more non-geostationary satellites; or
e. available physical cell identifiers for cells created by the one or more non-geostationary satellites.

13-17. (canceled)

18. An apparatus comprising:
at least one processor; and
at least one memory including computer program code, the at least one memory and computer program code configured to, with the at least one processor, cause the apparatus to perform:
searching, by a user equipment, for a public land mobile network;
in response to finding a public land mobile network transmitting, using a geostationary system, one or more messages comprising coverage information for one or more non-geostationary satellites in a non-terrestrial network, receiving by the user equipment the one or messages;
updating by the user equipment preferences used for a list used for public land mobile network selection to make one or more public land mobile networks corresponding to the coverage information as higher priority than other public land mobile networks in the list; and
performing by the user equipment one or more cell searches for cells from the one or more non-geostationary satellites using the updated list.

19. The apparatus according to claim 18, wherein the searching for a public land mobile network further comprises scanning, by the user equipment while listening to the geostationary system, radio frequency channels to search for a network, and the receiving is performed in response to finding the public land mobile network transmitting the one or more messages while performing the scanning.

20. The apparatus according to claim 18, wherein the apparatus is further caused to perform: listening by the user equipment to a public land mobile network based on priorities in the list, but where the user equipment does not try to register or register in the public land mobile network to which the user equipment is listening.

21. The apparatus according to claim 18, wherein the performing one or more cell searches comprises determining a time to wake up again and related coverage information to perform a next cell search in the non-terrestrial network based on the coverage information, the related coverage information comprising a cell and a corresponding public land mobile network in the non-terrestrial network to which to search.

22. The apparatus according to claim 21, wherein the apparatus is further caused to perform: after the time to wake up again, registering with the public land mobile network in the related coverage information, and connecting to the cell for the public land mobile network in the related coverage information.

23. The apparatus according to claim 22, wherein the apparatus is further caused to perform: after the user equipment disconnects from the non-terrestrial network, initiating by the user equipment a timer for validity of ephemeris acquired for future discoveries of the non-terrestrial network, wherein the non-terrestrial network in the related coverage information has precedence in a new public land mobile network search while the timer is still valid, but in response to the timer expiring, initiating public land mobile network search with the public land mobile network associated to the geostationary system instead of with the non-terrestrial network in the related coverage information.

24. The apparatus according to claim 18, wherein the one or more messages are system information block messages.

25. The apparatus according to claim 18, wherein the coverage information contains information for cell searches to be performed in the non-terrestrial network by the user equipment.

26. The apparatus according to claim 25, wherein the information for the cell searches comprises one of more of the following:
a time window where the one or more non-geostationary satellites will be available in the area of a current geostationary cell in the geostationary system;
the one or more public land mobile networks associated to the one or more non-geostationary satellites;
one or more frequency channels available in the one or more non-geostationary satellites; or
a coverage likelihood indicating how likely it is to get connectivity from the one or more non-geostationary satellites in the current geostationary cell.

27. The apparatus according to claim 25, wherein the information for the cell searches comprises a list comprising one or more of the following:
a. a further list of public land mobile networks that maintain roaming agreements for the one or more non-geostationary satellites with the public land mobile network associated to the one or more non-geostationary satellites;
b. ephemeris information of the one or more non-geostationary satellites;
C. beam polarization for the one or more non-geostationary satellites;
d. doppler pre-compensation used in the one or more non-geostationary satellites; or
e. available physical cell identifiers for cells created by the one or more non-geostationary satellites.

28. (canceled)
